(19) United States
(12) Patent Application Publication
(10) Pub. No.: US 2026/0169213 A1
(43) Pub. Date: Jun. 18, 2026

(54) VEHICLE WINDOW COMPRISING A COMPOSITE STRUCTURE

(71) Applicant: Webasto SE, Stockdorf (DE)

(72) Inventors: Matthias Baumann, Stockdorf (DE); Robert Pasquarelli, Stockdorf (DE)

(21) Appl. No.: 19/128,652

(22) PCT Filed: Oct. 11, 2023
(86) PCT No.: PCT/EP2023/078184

§ 371 Date: May 9, 2025

(30) Foreign Application Priority Data
Nov. 16, 2022 (DE) 10 2022 130 344.6

(51) Int. Cl. F21V 8/00

(52) U.S. Cl. CPC G02B 6/0055; G02B 6/0031; G02B 6/005; G02B 6/0068; G02B 6/0076

(57) ABSTRACT

The invention relates to a vehicle window (11), in particular a window in a vehicle roof (10), comprising a composite structure with a window outer body (16), a shading assembly (20), a window inner body (18) and a light-guiding layer (40), wherein the shading assembly (20) is arranged between the window outer body (16) and the window inner body (18), and comprises a switchable liquid crystal assembly (26). The shading assembly (20) comprises a carrier layer (15) which is arranged directly or indirectly on an outer side (41) of the light-guiding layer (40) orientated in the direction of the shading assembly (20), and which has a coating (17) made of a material with a refractive index n2, which is lower than a refractive index n1 of a material from which the light-guiding layer (40) is made.

The invention relates to a vehicle pane having the features of the preamble of claim 1.

Such a vehicle pane is known from practice and is especially employable in the region of a vehicle roof as a fixed roof element or also as a movable cover element of a roof opening system. The vehicle pane is configured as a laminate component which comprises a pane outer body which faces the vehicle environment and a pane inner body which faces the vehicle interior and forms an inner viewing surface of the vehicle pane. Often arranged between the pane inner body and the pane outer body is a shading assembly which comprises an electrically switchable liquid crystal assembly, i.e. a so-called LC layer or PDLC layer. The LC layer or PDLC layer is arranged between two films whose inner surfaces each have a transparent electrode arranged on them. The electrodes make it possible to switch the LC layer or the PDLC layer between a transmissive state and a blocking state.

In known applications the liquid crystal assembly and/or the plastic films are/is translucent or clear. To adapt the appearance of the vehicle, colored glass is used for the pane inner body and/or the pane outer body for example or colored/tinted (polymeric) adhesive films are utilized. The incorporation of colored films and the like into the laminate construction can lead to opacification of the vehicle pane due to increased haze. Furthermore, colored/tinted adhesive films especially result in increased costs compared to conventional transparent adhesive films since coloring and/or tinting is cost-intensive. The multiplicity of layers of the laminate construction which may also comprise colored intermediate layers additionally makes manufacturing complex and results in high manufacturing costs.

The prior art likewise discloses incoupling light from a light source into the light guide layer directly or using a prism or another type of incoupling element. The use of a prism or an incoupling element allows for a freer selection when placing the light source since the latter then need no longer be arranged directly in the edge region of the light guide layer. This design freedom has the advantage that, as opposed to an arrangement directly in the edge region of the light guide layer, the light source is no longer arranged in the wet region but may rather be provided in a dry region that is protected from moisture. This makes it possible to dispense with seals and/or moisture protection. For example the use of a prism that is applied for example to an inner surface of an inner surface serving as a light guide layer makes it possible to arrange a light source laterally below the edge region of the light guide layer, especially offset from the edge region. Light incoupling directly at an inner surface of a pane inner body is also possible. Vehicle panes where light is incoupled into the pane inner bodies via a light source arranged in an edge region of the vehicle pane are also known.

The known incoupling of light from a light source into a light guide layer unavoidably leads to light losses which adversely affect the light quality/light intensity of the light subsequently outcoupled from the light guide layer. These light losses may also have to be compensated by the use of stronger/brighter light sources and/or an increased number of light sources, thus resulting in additional costs. In the known light incoupling the light beams emanating from the light source are for example incoupled into the light guide layer not only via a light incoupling surface thereof and remain inside the light guide layer until outcoupling especially due to repeated total reflection. On the contrary at least a portion of the incoupled light beams passes through the pane inner body configured as a light guide layer in the direction of the pane outer body and for example penetrates into the polymer adhesive layer thereabove and/or into a shading assembly arranged above the polymer adhesive layer, especially at least one of the plastic films and/or the liquid crystal assembly and/or even into the tinted pane outer body. Especially in the case of tinted/colored/blackened polymer adhesive layers the light thus undesirably exiting the light guide layer is absorbed. This proportion of the light is no longer available for light outcoupling from the light guide layer, this being apparent in a lower luminance. The undesired light outcoupling from the light guide layer results inter alia from the fact that the incoupled light has a tendency to exit the light guide layer into an adjacent interface layer, for example an adjacent air layer or a polymer adhesive layer due to differences in the refractive indices of the different layers. This results in light losses. The closer the refractive index of a surrounding medium and/or material to the refractive index of the light guide layer/the pane inner body, the greater the light loss through undesired light outcoupling into a neighboring layer.

A solution known from the prior art is that of providing an outer surface of the pane inner body oriented toward a vehicle exterior and utilized as a light guide layer with a coating having a low refractive index in order thus to increase a difference between the refractive indices of the pane inner body and the coating such that a proportion of light undesirably outcoupled from the light guide layer decreases, thus making it possible to significantly reduce light losses. It is also known to laminate onto the outer surface of the pane inner body a film produced from a material having a lower refractive index than the pane inner body. This also makes it possible to significantly reduce light losses. However, such films are costly. Coating the pane inner body is also associated with great manufacturing complexity.

Exemplary prior art includes the documents US 2016/0 349 442A 1 , US 2016/0 325 528 A1 and DE 2021 20 100 843 U1 .

Although the prior art already discloses solutions for reducing light loss there is a need for further alternative solutions which especially allow cost-effective and simple manufacture of the laminate construction.

It is accordingly an object of the invention to develop a vehicle pane in such a way that the aforementioned disadvantages are at least partially minimized and especially a further technical alternative solution which especially allows for cost-effective and simple manufacture of the laminate construction and makes it possible to minimize light losses is provided.

This object is achieved according to the invention by the vehicle pane having the features of claim 1.

The dependent claims relate to advantageous embodiments of the invention. All combinations of at least two features disclosed in the description, the claims and/or the figures fall within the scope of the invention. It goes without saying that the foregoing relating to the vehicle pane applies equivalently to the vehicle and/or the vehicle roof according to the invention without being redundantly recited therefor. It especially goes without saying that idiomatic transformations and/or analogous substitution of respective terms in the context of customary linguistic practice, especially the use of synonyms supported by the generally recognized linguistic literature, are encompassed by the present disclosure content without being explicitly mentioned in their respective formulation.

The invention thus proposes a vehicle pane, especially a pane of a vehicle roof, comprising a laminate construction having a pane outer body, a shading assembly, a pane inner body and a light guide layer, wherein the shading assembly is arranged between the pane outer body and the pane inner body. The shading assembly comprises a liquid crystal assembly which is preferably arranged between two plastic films. According to the invention the shading assembly comprises a carrier layer which is arranged directly (i.e. especially without interposition of further layers) or indirectly (especially via at least one further layer, for example a polymer adhesive layer or a further adhesive layer) on the outer surface of the pane inner body. It is preferable for the invention when the tinting/a tinting function is realized within the shading assembly and not between a low-reflectance layer and the light guide layer. The invention is accordingly unsuitable if the tinting is realized via a tinted PVB arranged on the light guide layer. The carrier layer comprises a layer, especially a coating, composed of a material having a refractive index n2 lower than a refractive index n1 of a material from which the light guide layer is formed.

It is particularly preferable when the pane inner body is configured as the light guide layer.

However, the laminate construction may alternatively also comprise an additional layer configured as the light guide layer which is formed for example from a plastic. The light guide layer is preferably configured for conducting light incoupled into the vehicle pane.

When the liquid crystal assembly comprises at least one plastic film it is preferable when at least one of the plastic films and/or the liquid crystal assembly itself comprises a blackening and/or a tinting and/or a coloring. The tinting and/or blackening and/or coloring of the liquid crystal assembly and/or the plastic films can preferably realize a reduction in the brightness of the incident light through the vehicle pane. The liquid crystal assembly may be a liquid crystal layer (LC layer) or a polymer-dispersed liquid crystal layer (PDLC layer). The term “blackening” is in the present case to be understood in its broadest sense and comprises deep black, dark gray and also further coloring states.

Providing the carrier layer according to the invention which comprises a coating having a low refractive index makes it possible to dispense with a coating of the outer surface of the pane inner body often configured as a light guide layer, as practiced in the prior art. Furthermore, it is also possible to dispense with producing an entire film from a material having a low refractive index. This makes it possible to reduce costs relative to the solutions from the prior art. The solution according to the invention additionally has manufacturing advantages since for example the carrier layer may be configured as a simple plastic film which comprises the coating according to the invention and may preferably be purchased by the meter. By contrast, in a solution from the prior art each pane inner body would require individual coating, thus entailing increased manufacturing cost and complexity. The coating according to the invention has the result that light losses caused by light refraction can be effectively and efficiently reduced. It therefore increases a luminance achievable with the light guide layer, thus optionally allowing the at least one light source to be made smaller and thus saving space.

In a preferred embodiment the refractive index of the coating may be further reduced by making the coating/the layer porous. Such a porosity may be established for example by application of methods/processes, such as off-axis sputtering or sputtering with a grazing angle of incidence relative to the coating.

In a preferred embodiment the carrier layer is made of polycarbonate (PC), polyethylene (PE) and/or of polyethylene terephthalate (PET). Other plastic types are also possible. PC and PET are advantageous materials which are widely available.

In a preferred embodiment the coating is applied to a side of the carrier layer facing the outer surface of the light guide layer. The coating may be printed and/or vapor-deposited and/or otherwise applied.

In a preferred embodiment the coating comprises a fluoropolymer and/or an oxide, especially silica gel silicon dioxide (SiO₂), and/or magnesium fluoride (MgF₂). Silica gel is a colorless, amorphous silicon dioxide of gel-like or rubber-like to solid consistency. Crystalline silicon dioxide may be formed at high temperatures. Depending on the oxygen content present, coatings based on silicon oxide (SiOx) may form a combination of stoichiometric oxide (especially SiO2) with a nonstoichiometric suboxide (for example SiOx, x<2, based on SiO2 as the stoichiometric base oxide). As a powder it is strongly hygroscopic and suitable as a gelling agent, filtration agent, adsorption agent and drying agent. As a thin film it is suitable as an insulation and passivation material in the fields of semiconductor and optics technology. Magnesium fluoride (MgF2) is a material having a transparency in the wavelength range between 0.12 μm and 7.5 μm. It is also birefractive. The combination of these two properties allows the production of polarizing optics.

In a preferred embodiment a difference between the refractive index n1 of the pane inner body and the refractive index n2 of the coating is not less than (≥) 0.06.

Alternatively or in addition the refractive index n2 of the coating is not more than (≤) 1.46. The refractive index n1 of the pane inner body is preferably 1.52. The refractive index of the first and/or of the second polymer adhesive layer is preferably 1.48. In other embodiments the refractive index n2 of the optical insulation layer may be between 1.3 and 1.52, wherein the refractive index may particularly preferably also be ≤1.45. The refractive index of the solid body may be further reduced by increasing the proportion of porosity in the material.

In a preferred embodiment the carrier layer forms an electrode of the liquid crystal assembly on its side facing the shading assembly and/or comprises a tinting and/or coloring and/or blackening. In embodiments the carrier layer may thus be a multifunctional film which provides not only the coating having a low refractive index but also further functions for the vehicle pane and/or the shading assembly. A tinting of the carrier layer may be preferred since the coating having a low refractive index prevents light absorption through the tinted region of the carrier layer. In the case of a tinting and/or coloring the coating is particularly preferably arranged on the side of the carrier layer facing the pane inner body. Since the coating faces the outer surface of the light guide layer and is optionally bonded thereto via a polymer adhesive layer (for example referred to as the second polymer adhesive layer), wherein the polymer adhesive layer is preferably transparent, the coating causes light undesirably outcoupled from the light guide layer to be incoupled back into the light guide layer. In other embodiments the carrier layer may also itself be configured as an adhesive layer and comprise the coating. Direct bonding to the outer surface of the light guide layer is thus possible.

In a preferred embodiment the shading assembly comprises further tinted and/or colored and/or transparent plastic layers and/or further, especially transparent, adhesive layers and/or a layer for reflecting infrared radiation. The shading assembly may accordingly have a multilayer construction. In addition, the individual layers may in turn be divided into a multiplicity of layers. Thus for example a plastic film of the shading assembly may itself comprise a plurality of layers and thus form a film laminate.

The carrier layer is particularly preferably formed by the at least one plastic layer of the shading assembly which is adjacent to the liquid crystal assembly and/or is formed by the at least one polymer adhesive layer and/or by the further adhesive layer.

The carrier layer is particularly preferably configured as a tinted plastic layer of the shading assembly. This also makes it possible to dispense with providing a further carrier layer and the already present plastic layer of the shading assembly may be utilized synergistically. The functionality of the tinted plastic layer of the shading assembly which preferably delimits the liquid crystal assembly at least on one side is thus extended relative to the prior art by the provision of the coating. The plastic films of the shading assembly preferably comprise polycarbonate, polyethylene or polyethylene terephthalate.

As mentioned above, at least one of the plastic films and/or the liquid crystal assembly may preferably have a blackening and/or a tinting and/or a coloring. Such a liquid crystal assembly makes it possible to dispense with further tinted intermediate layers or a colored pane inner body to adapt the vehicle pane to the light transmittance. It is likewise possible to dispense with a multiplicity of optionally colored intermediate films and/or colored polymer adhesive layers or the like which, compared to known vehicle panes, can in turn lead to lower opacification (preferably also lower haze) and thus to a better visual appearance. The vehicle pane nevertheless meets high safety requirements, including when used as a cover element of a roof opening system or as a fixed roof element of a vehicle roof.

In the case of a tinting of the at least one plastic layer of the shading assembly, preferably present polymer adhesive layers of the vehicle pane may be transparent and/or at least semitransparent, especially untinted. Compared to the prior art this results in a substantially lower light absorption by the polymer adhesive layer. This increases the amount of light available for light outcoupling. The lower light losses make it possible, alternatively or in addition, to reduce the amount of scattering particles in a color of the light outcoupling structure/of the light extraction element while leaving brightness unchanged. This makes the light outcoupling structure less visible within the vehicle pane in daylight for example, thus resulting in an improved optical impression for the customer. Dispensing with the tinting and/or the blackening and/or the coloring in the first and/or second polymer adhesive layer additionally reduces the haze of the overall laminate construction, with the result that the vehicle pane as a whole appears more transparent to a customer. In addition, this also reduces the contrast. In addition, the use of cheaper, untinted polymer adhesive layers makes it possible to achieve cost savings in preferred embodiments. The coating of the carrier layer according to the invention makes it possible to further minimize light losses especially in combination with such an embodiment.

The transmittance of the laminate construction for visible light is preferably low both in the transmissive state and in the blocking state of the liquid crystal assembly, thus preferably resulting in a low light admittance through the vehicle pane into the vehicle interior.

A preferably tinted and/or colored and/or blackened shading assembly preferably exhibits a strong absorption of electromagnetic radiation in a wavelength range between 350 nm and 2500 nm. For visible light the transmittance is preferably below 30%. For infrared radiation in the range between 700 nm and 2500 nm too, the transmittance may preferably be below 40%.

The preferred blackening of the liquid crystal assembly may be defined in the Lab color space especially by the color coordinates L, a and b, wherein L<30, −15<a<15 and −15<b<15.

The preferred blackening of at least one plastic film of the shading assembly (if present) and/or of the liquid crystal layer, i.e. especially of the polymer of the liquid crystal layer, may be adjusted through the use of suitable colorants and/or through suitable selection of the employed materials and their chemistries.

In a preferred embodiment the liquid crystal assembly comprises a polymer-dispersed liquid crystal layer comprising a multiplicity of liquid crystals arranged in a matrix, wherein the multiplicity of liquid crystals and/or the matrix are/is colored and/or tinted and/or blackened. Alternatively, the liquid crystal assembly may comprise no carrier matrix, as is the case in an LC layer.

The preferred opacification of the shading assembly in the transmissive state of the liquid crystal assembly is preferably at most 5%.

The preferably present plastic films of the shading assembly preferably each have a transparent electrode on their inner surfaces so that the adjacent liquid crystal assembly may be switched by changing the electric field between the blocking state and the transmissive state. Alternatively, the carrier layer may also comprise such a transparent electrode.

The plastic films and/or the carrier layer according to the invention may especially be in the form of PET (polyethylene terephthalate) film, COP (cyclic olefin polymer) film or else PC (polycarbonate) film and be coated with ITO (indium tin oxide) or PEDOT: PSS to form the electrodes for the liquid crystal assembly.

The liquid crystal assembly may be a PNLC (polymer network liquid crystal) layer where the transmissive state is produced by applying a voltage and the blocking state is in effect in the absence of a voltage. Alternatively the layer may be a layer where a voltage is applied in every switching state. This is then a so-called inverse, bistable PDLC layer. PDLC is a polymer liquid crystal assembly (polymer-dispersed liquid crystal). Irrespective of the selected PDLC layer variant the PDLC layer may be segmented or provided with a pattern. The liquid crystal assembly may alternatively be an LC layer. PDLC inter alia has the advantage that there is no change in brightness but rather only a change in the haze (opacity) of the pane and thus in the transparency. In a PDLC-based liquid crystal assembly it is preferable when only the haze is altered.

The preferred blackening and/or tinting of the shading assembly makes it possible to reduce the transmittance for visible light directly incident onto the liquid crystal assembly preferably to values below 2% and especially even below 1% in the blocking state of the liquid crystal layer. In the transmissive state of the liquid crystal layer the transmittance for visible light is preferably in a range between 2% and 30%. This is particularly preferable in the case of an LC liquid crystal assembly.

To ensure the functionality of the shading assembly even at high outside temperatures the laminate construction may comprise in a preferred embodiment of the vehicle pane according to the invention at least one layer for reflecting infrared radiation on the side of the liquid crystal assembly facing the pane outer body. This makes it possible to avoid undesired malfunctions that could result from absorption of heat by the liquid crystal assembly.

The reflectance of the layer for reflecting infrared radiation is preferably more than 60%. Especially in the case of a reflectance of the layer of less than 60% for infrared radiation, for example of 2% to <60%, a further layer for reflecting infrared radiation may be provided between the pane outer body and the shading assembly. This further layer may additionally be arranged on the shading assembly and/or at least one plastic film of the shading assembly and/or between such a plastic film and the liquid crystal assembly, for example on an additionally applied film which may accordingly be an IR-coated PET film or else on the underside of the pane outer body or else between the pane outer body and the shading assembly in any other way. The additional layer makes it possible to achieve a total reflectance for infrared radiation of the laminate construction of at least 60%.

In a specific embodiment of the vehicle pane according to the invention the layer for reflecting infrared radiation is arranged on the film of the shading assembly facing the pane outer body, namely in the form of a direct coating or an additional coated film that is provided with the layer and comprised by the shading assembly. The layer for reflecting infrared radiation thus forms a coating of this film. In a special embodiment of the vehicle pane according to the invention at least one plastic layer of the shading assembly that is preferably present is provided with a layer for reflecting infrared radiation.

It is also conceivable for the layer for reflecting infrared radiation to be arranged on the inner surface of the pane outer body.

To maintain a particularly high reflectance for infrared radiation and maintain a high transmittance for visible light in a specific embodiment of the vehicle pane according to the invention the layer for reflecting infrared radiation has a multilayer construction which represents a so-called thermal layer or thermal coating or low-E (low-emissivity) coating. Configuring the layer for reflecting infrared radiation as a multilayer construction results in a high reflectance especially in the wavelength range between 650 nm and 2500 nm.

A high reflectance may especially be achieved when the layer for reflecting infrared radiation/the individual layers of the multilayer construction is/are formed from at least one of the substances from the group comprising metals, such as gold, silver and copper, and oxides, such as tin oxide, titanium dioxide, zinc oxide, indium tin oxide, fluorinated tin oxide, zinc tin oxides and aluminum oxide.

The shading assembly preferably provided with a blackening provides a positive optical appearance especially in conjunction with black ceramic frits. Protection against infrared radiation is ensured by the corresponding reflective coating of the shading assembly. The reflective coating protects not only the vehicle interior from excessive heat inflow but also the liquid crystal layer so that the functioning thereof remains assured even at high outside temperatures.

The laminate construction of the vehicle pane may preferably comprise a further thermal layer (low-E layer) which is preferably provided on the inner surface of the pane inner body. Such a low-E layer is preferably connected to the inner surface of the pane inner body via a further carrier layer having a low refractive index. All of the foregoing relating to the carrier layer according to the invention applies to the further carrier layer. It is preferable when the pane inner body forms the light guide layer. By providing the further low-E layer on the inner surface a heat outflow from the vehicle can be minimized. A low-E layer at least partially absorbs and/or reflects light of a particular spectrum from the light guide which would lead to a color drift (color coordinate inhomogeneity through color coordinate shift between an input color of the light source and the light after absorption/reflection by the low-E layer) of the light from the incoupling point to the center of the light guide and with increasing distance from the light source in the light guide. Especially light in the red spectrum is absorbed by a low-E layer. The further carrier layer having a low refractive index leads to a lower outcoupling of light from the light guide into the low-E layer and thus results in a reduction of a color coordinate inhomogeneity of light in the light guide. In addition, the luminance in the light guide is virtually retained and thus results in a higher luminance in the light guide over its areal extent compared to the embodiment without a further carrier layer. It is further possible to configure the liquid crystal assembly such that it may be switched in segments and/or continuously switched between the transmissive state and the blocking state.

In a specific embodiment of the vehicle pane according to the invention the pane inner body and the pane outer body are each curved, namely in the pane longitudinal direction and/or in the pane transverse direction. The curvature radius defining the curvature may vary in the relevant direction and for example have a value between 1000 mm and 10 000 mm, especially between 2000 mm and 5000 mm. The shading assembly can follow the curvatures.

It is particularly preferable when the vehicle pane comprises at least one polymer adhesive layer, hereinbelow also referred to for example as the first and second polymer adhesive layer. It is preferable when the shading assembly (using one of its layers) is bonded to the pane outer body especially directly or indirectly (i.e. optionally with interposition of at least one further layer) via a first polymer adhesive layer and bonded to the pane inner body especially directly or indirectly (i.e. optionally with interposition of at least one further layer) via a second polymer adhesive layer. It is also possible, for example when the shading assembly itself comprises further adhesive layers, to provide only one polymer adhesive layer which makes it possible to realize direct bonding to the pane inner body for example. The shading assembly comprises a liquid crystal assembly which is particularly preferably arranged between two plastic films.

The bonding of the shading assembly to the pane outer body and to the pane inner body may in each case be effected using (a first and/or second) polymer adhesive film directly or with interposition of further layers which may in turn be bonded via adhesive layers.

The preferred polymer adhesive films are for example formed from a thermoplastic polyurethane (TPU), ethylene vinyl acetate (EVA), polyvinylbutyral (PVB), an epoxide, silicone, polyethylene terephthalate or from any other transparent plastic film. The refractive index of the polymer adhesive film employed in each case is preferably in the range of that of the pane inner body/of the pane outer body and for example has a value of for instance 1.5.

In preferred embodiments the vehicle pane furthermore comprises at least one light source configured for incoupling light into the light guide layer especially directly via an inner surface of the pane inner body and/or via an incoupling element. For light outcoupling the outer surface of the light guide layer is preferably provided with a light outcoupling structure which is configured for outcoupling the light incoupled into the light guide layer back out of the pane inner body in the direction of a vehicle interior, especially directionally and/or in a predetermined manner which is preferably defined by the light outcoupling structure. The light source is preferably an LED light source and/or comprises a multiplicity of light emitting diodes. The outer surface of the light guide layer is preferably opposite an inner surface of the pane inner body when viewing the laminate construction.

In order also to be able to employ the vehicle pane according to the invention as a so-called ambient light component which forms a flat or structured illuminating body in the vehicle interior at least one light source is provided according to the invention, wherein the pane inner body forms a light guide layer into which light from the light source may be incoupled such that the pane inner body is illuminated in its entirety or in defined segments. The functions of a switchable glass, of an optional thermal protection and of an ambient light illumination are integrated in accordance with the invention into the vehicle pane according to the invention. The shading assembly according to the invention promotes the ambient light effect. It is particularly preferable when the at least one light source is arranged indirectly or directly on the inner surface of the pane inner body so that light is incoupled directly via the inner surface of the pane inner body. Alternatively or in addition, the incoupling element is arranged on the inner surface of the pane inner body and the light source is arranged on a lateral surface of the incoupling element, with the result that light emitted by the light source may be deflected by the incoupling element and incoupled into the light guide layer. The incoupling element is preferably a material body transparent to the light from the light source which is bar-like and/or has a wedge-shaped or trapezoidal cross section. The incoupling element is preferably in the form of a prism which is bonded onto the inner surface. The incoupling element is particularly preferably a prism. A white and/or translucent scattering structure and/or a structured film for perpendicular light incoupling may be employed alternatively or in addition.

In a preferred embodiment the incoupling element is a material body transparent to the light of the light source which is bar-like and/or has a wedge-shaped or trapezoidal cross section. The incoupling element is preferably arranged close to the edge on the inner surface of the pane body assembly. Light may then be incoupled into the light guide layer of the pane body assembly over the extent of the bar-like incoupling element. The incoupling element may be designed for example as an optical prism.

The incoupling element is preferably manufactured from a material comprising PMMA (polymethyl methacrylate), PC (polycarbonate), PA (polyamide), COC (cycloolefin copolymer) or COP (cycloolefin polymer). A refractive index of the incoupling element is especially adapted to the refractive index of the adjacent light guide layer and preferably has a value of between 1.40 and 1.65 and in particular between 1.48 and 1.59. Production of the incoupling element is preferably carried out after an extrusion process or an injection molding process. Alternatively or in addition the incoupling element may be made of glass or resin and/or of transparent polyurethane and preferably be arranged on the pane body assembly. In order to improve internal reflection, the incoupling element may be provided with a reflective coating which may comprise metals such as aluminum or silver and may be applied by a vapor deposition or sputtering process. In order to further improve the incoupling behavior of the light into the light guide layer in one advantageous embodiment of the vehicle pane according to the invention an additional deflection structure is arranged between the incoupling element and the pane body assembly. The additional deflection structure makes it possible to alter the angle of incidence of the light onto the light guide layer by corresponding refraction to increase the internal reflection in the light guide layer. The additional deflection structure may comprise a series of asymmetrical prisms which have dimensions in the millimeter range or in the micrometer range and which are arranged as a three-dimensional array or linearly, as is the case for a Fresnel lens array for example. The additional deflection structure may be integral with the incoupling element and may be formed directly during manufacture thereof, for example during an extrusion process or an injection molding process. It is also conceivable for the additional deflection structure to form a coating of the incoupling element, for example in the form of a separate structured film.

In a preferred embodiment the incoupling element is bonded to the pane body, especially to the inner surface, via an adhesive layer. The adhesive layer which preferably has a refractive index between 1.40 and 1.65 and especially between 1.48 and 1.56 may be formed from any desired adhesive suitable for optical use. By way of example the adhesive layer is formed from a pressure sensitive adhesive, a liquid optically clear adhesive (LOCA), EVA (ethylene vinyl acetate), PVB (polyvinylbutyral), TPU (thermoplastic polyurethane), an epoxy adhesive or an acrylate adhesive. The selected materials preferably each have a refractive index which minimize a refraction of the light beams at the interfaces and optimize the incoupling efficiency at the ideal angle conditions.

In one embodiment the light source is arranged such that the main emission direction thereof is oriented perpendicular to the main surface of the pane inner body and faces the pane inner body. A light scattering assembly is arranged on the side of the inner pane body opposite the light source. The light scattering assembly is arranged in such a way that light from the light source which is incoupled into the pane inner body is scattered such that the majority of the incoupled light guided to the light scattering assembly is reflected back in all possible spatial directions to be guided inside the pane body by total reflection. The light scattering assembly may for example be a print, for example with white ink, a surface structuring and/or a coating. A further light scattering assembly and/or a reflector may be arranged on the surface of the pane inner body facing the light source in the region of the light source, preferably with a cutout at the light source for direct and preferably virtually perpendicular (for example +/−30°) incoupling into the pane inner body.

The light source may further comprise a background reflector and/or a background light scattering assembly so that light from the light source which is not incoupled into the pane inner body is reflected/scattered back again onto the pane inner body.

In one embodiment the light source is arranged such that light from the light source is incoupled mainly via a lateral edge of the pane inner body, i.e. the lateral surface which runs substantially perpendicular or at an angle to the flat orientation of the pane inner body. The light source is preferably arranged offset to the pane inner body laterally in a flat orientation of the pane inner body.

To optimize the light incoupling into and the light outcoupling out of the pane inner body in a special embodiment of the vehicle pane according to the invention the plastic film of the shading assembly facing the pane inner body has arranged on it a reflective layer for reflecting visible light which has a reflectance of preferably at least 2% and/or which can form a layer for reflecting infrared radiation. The ambient light effect is additionally amplified by internal reflection in the pane inner body.

The reflective layer for reflecting visible light may likewise be configured as a multilayer construction or as a single layer. The single layer or the layers of the multilayer construction may each be formed from at least one of the substances from the group comprising for example silver, gold, copper, tin oxide, titanium dioxide, zinc oxide, indium tin oxide, fluorinated tin oxide, zinc tin oxides and aluminum oxide.

In a specific embodiment the preferably tinted and/or colored and/or blackened liquid crystal assembly and/or the two plastic films which are particularly preferably provided with the reflective layers make it possible to outcouple a proportion of for example at least 2% of the light introduced by the light source in the direction of the vehicle interior.

In a preferred embodiment the vehicle pane comprises a light outcoupling structure as mentioned above. Such a light outcoupling structure may be printed and/or applied on the carrier layer, wherein the carrier layer is laminated on the outer surface of the light guide layer, especially via a polymer adhesive layer (as mentioned above) or a further adhesive layer. The preferred light outcoupling structure may alternatively be printed and/or applied directly on the outer surface. Other embodiments of a light outcoupling structure are also conceivable as elucidated below.

To improve the outcoupling of the light from the light guide layer in the direction of the vehicle interior it is advantageous when scattering centers are provided at the reflective layer for reflecting visible light and/or at the light outcoupling structure.

Alternatively or in addition scattering centers may also be integrated in the light outcoupling structure and/or directly in an outer surface opposite the inner surface of the pane inner body or be applied on at least one of the surfaces of the pane inner body. Scattering enters/scattering media are preferably arranged between the shading assembly and the pane inner body.

The light scattering centers may be made of any suitable material/medium, for example of particles of an opaque organic, inorganic, especially ceramic, material, of a transparent, semitransparent or else opaque print, or of a pattern or a structure produced on the pane inner body by etching, engraving or by laser ablation. The semitransparent material may be directly printed onto glass and/or be in the form of a printed film between two glass layers.

The pane outer body and the pane inner body of the vehicle pane according to the invention may be manufactured from clear glass or any other suitable glass or manufactured from a plastic material, such as polycarbonate. In a specific embodiment the pane inner body may also be formed from a hard, impact-resistant and scratch-resistant coating formed on the side of the shading assembly facing away from the pane outer body.

The invention further relates to a vehicle and/or vehicle roof comprising at least one vehicle pane, wherein the vehicle pane may be a cover element of a roof opening system and/or a fixed roof element.

The vehicle pane may be for example a windshield and/or a front pane and/or a rear pane and/or a side pane and/or a side glazing and/or an interior partition of a vehicle.

It goes without saying that the embodiments and exemplary embodiments mentioned above and still to be elucidated below are configurable not only alone but also in any desired combination with one another without departing from the scope of the present invention. It likewise goes without saying that the embodiments and exemplary embodiments mentioned above and still to be explained below relate to all embodiments of the invention in equivalent or at least similar fashion without being separately recited in each case.

Basic embodiments and specific embodiments of the invention are shown in schematic form in the drawings and are elucidated by way of example hereinbelow. In the figures:

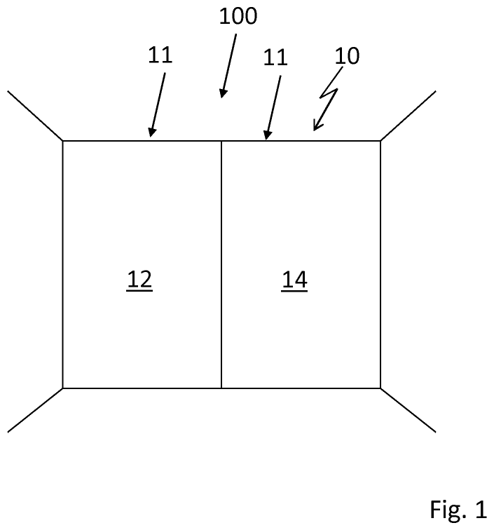

FIG. 1 shows a schematic plan view of a vehicle roof comprising a vehicle pane according to the invention;

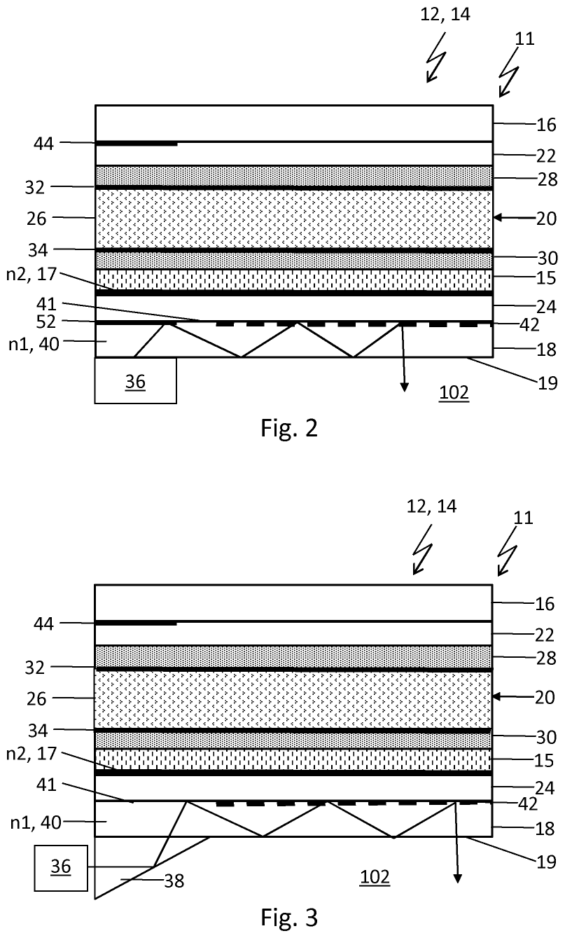

FIG. 2 shows a schematic section through an exemplary vehicle pane;

FIG. 3 shows a schematic section through an exemplary vehicle pane;

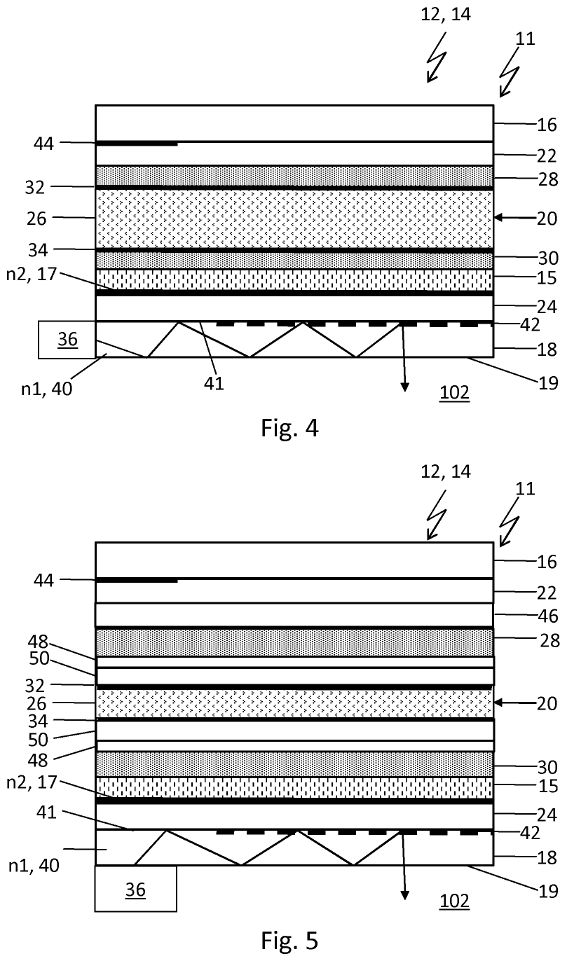

FIG. 4 shows a schematic section through an exemplary vehicle pane; and

FIG. 5 shows a schematic section through an exemplary vehicle pane.

FIG. 1 shows a vehicle roof 10 of a motor vehicle 100 which is not otherwise shown in detail. The vehicle roof 10 is a panoramic roof having an adjustable cover element 12 and a fixed roof element 14, which is fixedly or immovably connected to the vehicle body. The cover element 12 and the fixed roof element 14 are each in the form of a glass element and accordingly in the form of a vehicle pane 11. The cover element 12 and the fixed roof element 14 have the same or distinct laminate constructions as shown schematically in different variants in FIGS. 2 to 5.

Alternatively, the vehicle roof 10 may comprise a second fixed roof element 14 instead of the roof element 12 or a single fixed roof element 14 instead of the fixed roof element 14 and the roof element 12. The roof elements 12 and 14 in each case configured as the vehicle pane 11 each represent a laminate component comprising a pane outer body 16 and a pane inner body 18. The pane outer body 16 and the pane inner body 18 are each manufactured from a soda lime glass but may also be produced from other materials, for example from a plastic.

The pane outer body 16 faces the vehicle environment while the pane inner body 18 faces a vehicle interior 102 with an inner surface 19 and forms an inner viewing surface of the vehicle pane 10.

Provided between the pane outer body 16 and the pane inner body 18 is a shading assembly 20 which is bonded to the pane outer body 16 via a first polymer adhesive layer 22/an adhesive layer. According to the invention the shading assembly 20 comprises a carrier layer 15 which comprises a coating 17 explained in more detail below. Purely by way of example the carrier layer 15 is bonded to the pane inner body 18 via a second polymer adhesive layer 24 and/or via a further adhesive layer.

It will be appreciated that in other embodiments further layers, especially functional layers, such as a layer for reducing infrared incident radiation, may be provided and/or interposed between the pane outer body 16 and the first polymer adhesive layer 22. It goes without saying that in other embodiments further layers, especially functional layers, may be provided and/or interposed between the first polymer adhesive layer 22 and the shading assembly 20. It goes without saying that further layers, especially functional layers, may be provided and/or interposed between the shading assembly 20 and the second polymer adhesive layer 24. It goes without saying that further layers, especially functional layers, may be provided and/or interposed between the second polymer adhesive layer 24 and the pane inner body 18. Such functional layers may for example supplement and/or expand and/or improve a function of the vehicle pane.

The shading assembly 20 comprises a liquid crystal assembly (LC layer or PDLC layer) 26. The liquid crystal assembly 26 comprises a multiplicity of crystals in a matrix assembly within the liquid crystal layer. The liquid crystal assembly 26 is delimited on both sides by respective plastic films 28, 30 belonging to the shading assembly 20. The plastic films 28, 30 may be produced from PET for example. While the carrier layer 15 and the plastic film 30 are shown as separate this serves only for elucidation of the construction. However it may be preferable for the carrier layer 15 to be formed by the plastic film 30 itself.

Respective transparent electrodes 32 and 34 are arranged on the inner surface of the plastic films 28 and 30. The electrodes 32 and 34 can be used to apply a voltage to the liquid crystal assembly 26 so that the liquid crystal assembly 26 may be switched between a blocking state and a transmissive state by changing the orientation of the multiplicity of crystals.

In the exemplary embodiment shown the plastic films 28 and 30 and/or the liquid crystal assembly 26 have/has a tinted and/or black coloring produced using a colorant dispersed in the respective material. The tinting and/or blackening and/or coloring of the crystals and/or of the matrix of the polymer-dispersed liquid crystal layer 26 is known in the prior art as dye-dope technology.

The liquid crystal assembly 26 may be connected such that in the blocking state where no voltage is applied to the electrodes 32 and 34 it has a transmittance for visible light of less than 3%. In the transmissive state where a voltage is applied to the electrodes 32 and 34 the shading assembly 20 is transparent to visible light to the extent that a proportion of about 10% passes through it as a result of the black coloring of the plastic films 28 and 30 and/or of the liquid crystal assembly 26.

To provide an ambient light function in the form of a surface illumination means the vehicle pane 11 comprises at least one light source 36. According to FIG. 2 the light source 36 is arranged directly on the inner surface 19 of the pane inner body 18 and especially bonded thereto. The light source 36 may also be arranged spaced apart from the inner surface 19 of the pane inner body 18 (not shown). A light scattering assembly 52 is arranged on the side of the pane inner body opposite the light source 36. Light incoupling may alternatively be achieved by arranging an incoupling element 38 on the inner surface 19 of the pane inner body 18, especially bonding it to the inner surface 19, see FIG. 3. The incoupling element 38 allows the light source 36 to be arranged laterally next to the pane inner body 18 as is apparent from FIG. 3. This increases the design freedom when placing the light source 36. The incoupling element 38 is configured for redirecting light emitted by the light source 36 and thus incoupling it into the pane inner body 18 via the inner surface 19. The pane inner body 18 forms a light guide layer 40 for the light incoupled into it.

In an alternative embodiment FIG. 4 shows a lateral light incoupling, wherein the light source 36 is schematically arranged in a lateral region of the light guide layer 40/the pane inner body 18. Otherwise, the construction of the vehicle pane 11 corresponds to the construction known from FIG. 2.

On an outer surface 41 of the pane inner body 18 opposite the inner surface 19 of the pane inner body 18 a light outcoupling structure 42 is provided and configured for outcoupling again the light incoupled into the light guide layer 40 from the pane inner body 18 in the direction of the vehicle interior 102 in a predefined manner especially predetermined by the light outcoupling structure 42. The light outcoupling structure 42 is preferably printed and/or vapor-deposited and/or coated and/or laminated on the outer surface 41 of the pane inner body 18.

In an edge region of the vehicle pane 11 utilized for light incoupling and on which the light source 36 is arranged a light shielding element 44 may further be provided in sections, especially between the pane outer body 16 and the first polymer adhesive layer 22. The light shielding element 44 may for example be printed and/or applied as a lamination layer on the pane outer body 16 and/or on the first polymer adhesive layer 22.

The carrier layer 15 comprises the coating 17 on a side oriented toward the outer surface 41 of the pane inner body 18. The coating 17 is made of a material having a refractive index n2 which is lower than a refractive index n1 of a material from which the pane inner body 18 is made. The carrier layer 15 is preferably made of polycarbonate or of polyethylene terephthalate. The coating 17 comprises SiO₂ and/or MgF₂. It is preferable when a difference between the refractive index n1 of the pane inner body 18 and the refractive index n2 of the coating 17 is ≥0.06. It is particularly preferable when the refractive index n2 of the coating 17 is ≤1.46. In other embodiments the refractive index n2 of the coating 17 may be between 1.3 and 1.52, wherein the refractive index may particularly preferably also be ≤1.45.

As shown in the exemplary embodiment in FIG. 5 the shading assembly 20 may comprise further tinted and/or colored and/or transparent plastic layers 15 and/or further, especially transparent, adhesive layers and/or a layer for reflecting infrared radiation.

Starting from a vehicle exterior viewed in the direction of the vehicle interior 102 the vehicle pane 11 shown in FIG. 5 comprises the following exemplary multilayer construction. The pane outer body 16 is bonded via the first polymer adhesive layer 22/hot melt adhesive layer to an optional layer 46 for reflecting infrared radiation. The layer 46 is followed by the tinted plastic film 28 which is bonded via a transparent adhesive layer 48, for example an optically transparent adhesive layer (OCA layer) or a silicone gel, to a transparent further plastic film 50. The plastic film 50 is followed by the electrode 32 which adjoins the liquid crystal assembly 26 (LC layer or PDLC layer). Electrode 34 is provided opposite electrode 32 on the side of the liquid crystal assembly 26 facing the vehicle interior 102. This is followed by a further transparent plastic film 50. The plastic films 50 may serve as the respective carriers of the electrodes 32 and 34. The transparent plastic film 50 is bonded via a further transparent adhesive layer 48, for example an optically transparent adhesive layer (OCA layer), to the tinted plastic film 30 which is followed by the inventive carrier layer 15 having the coating 17, wherein the carrier layer 15 is bonded to the pane inner body via the second polymer adhesive layer 24.

In other embodiments the carrier layer 15 may also be formed by one of the further transparent adhesive layers 48. In this case it would even be possible to dispense with the polymer adhesive layer 24 so that the carrier layer 15 in the form of an adhesive layer 48 is directly laminated on the outer surface 51 of the light guide layer 50.

The remaining construction/the remaining description is apparent from the description relating to FIGS. 2 and 3.

### LIST OF REFERENCE NUMERALS

10 Vehicle roof
11 Vehicle pane
12 Cover element
14 Fixed roof element
15 Carrier layer
16 Pane outer body
17 Coating
18 Pane inner body
19 Inner surface
20 Shading assembly
22 Polymer adhesive layer
24 Polymer adhesive layer
26 Liquid crystal assembly
28 Plastic film
30 Plastic film
32 Electrode
34 Electrode
36 Light source
38 Incoupling element
40 Light guide layer
41 Outer surface
42 Light outcoupling structure
44 Light shielding element
46 Layer for reflecting infrared radiation
48 Adhesive layer
50 Further plastic film
52 Light scattering assembly
100 Vehicle
102 Vehicle interior
n1 Refractive index
n2 Refractive index

1. A vehicle pane comprising a laminate construction having a pane outer body, a shading assembly, a pane inner body and a light guide layer wherein the shading assembly is arranged between the pane outer body and the pane inner body and comprises a switchable liquid crystal assembly, characterized in that the shading assembly comprises a carrier layer which is arranged directly or indirectly on an outer surface of the light guide layer oriented toward the shading assembly and comprises a coating made of a material having a refractive index n2 which is lower than a refractive index n1 of a material from which the light guide layer is made.

2. The vehicle pane as claimed in claim 1, characterized in that the carrier layer comprises polycarbonate, polyethylene (PE) and/or polyethylene terephthalate (PET).

3. The vehicle pane as claimed claim 1, characterized in that the coating is applied on a side of the carrier layer facing the outer surface of the light guide layer

4. The vehicle pane as claimed in claim 1, characterized in that the coating comprises a fluoropolymer and/or an oxide and/or SiO₂ and/or MgF₂.

5. The vehicle pane as claimed in claim 1, characterized in that a difference between the refractive index n1 of the light guide layer and the refractive index n2 of the coating is ≥0.06 and/or in that the refractive index n2 of the coating is ≤1.46.

6. The vehicle pane as claimed in claim 1, characterized in that the carrier layer forms an electrode of the liquid crystal assembly on its side facing the shading assembly and/or comprises a tinting and/or coloring and/or blackening.

7. The vehicle pane as claimed in claim 1, characterized in that the shading assembly comprises at least one tinted and/or colored and/or transparent plastic layer and/or further, adhesive layers and/or a layer for reflecting infrared radiation

8. The vehicle pane as claimed in claim 7, characterized in that the carrier layer is formed by the at least one plastic layer and/or the further adhesive layer

9. The vehicle pane as claimed in claim 7, characterized in that the plastic films of the shading assembly comprise polycarbonate, polyethylene (PE) and/or polyethylene terephthalate (PET).

10. The vehicle pane as claimed in claim 1, characterized in that the vehicle pane comprises a light source configured for incoupling light into the light guide layer directly via an inner surface of the pane inner body and/or via an incoupling element.

11. The vehicle pane as claimed in claim 10, characterized in that the light outcoupling structure is printed and/or applied on the carrier layer which is laminated on the outer surface of the light guide layer outcoupling

12. The vehicle pane as claimed in claim 10, characterized in that the incoupling element is arranged on the inner surface of the pane inner body and the light source is arranged on a lateral surface of the incoupling element with the result that light emitted by the light source may be deflected by the incoupling element and incoupled into the light guide layer.

13. The vehicle pane as claimed in 10, characterized in that the incoupling element is a material body transparent to the light of the light source and is bar-like and/or has a wedge-shaped or trapezoidal cross section.

14. The vehicle pane as claimed in claim 1, characterized in that the shading assembly is bonded to the pane outer body and the pane inner body via at least two polymer adhesive layers, wherein the at least two polymer adhesive layers each form a hot melt adhesive layer, especially a polyvinylbutyral layer and/or an ethylene vinyl acetate layer and/or a thermoplastic polyurethane layer.

15. A vehicle and/or vehicle roof comprising a vehicle pane according to any claim 1, wherein the vehicle pane is a cover element of a roof opening system or a fixed roof element.

16. The vehicle pane as claimed in claim 10, characterized in that the light outcoupling structure is printed and/or applied directly on the outer surface of the light guide layer.

17. The vehicle pane as claimed in claim 10, characterized in that the light outcoupling structure is printed and/or applied directly on the outer surface of the pane inner body.
